(19) United States
(12) Patent Application Publication
(10) Pub. No.: US 2011/0314680 A1
(43) Pub. Date: Dec. 29, 2011

(54) Shearing Tool

(75) Inventors: Shisong Zhang, Jiangsu (CN); Xiangqing Li, Jiangsu (CN); Lixiang Huo, Jiangsu (CN)

(73) Assignee: POSITEC POWER TOOLS (SUZHOU) CO., LTD., Suzhou City, Jiangsu Province (CN)

(21) Appl. No.: 13/255,107

(22) PCT Filed: Mar. 8, 2010
(86) PCT No.: PCT/CN2010/070916

§ 371 Date: Sep. 6, 2011

(30) Foreign Application Priority Data
Mar. 6, 2009 (CN) 200910127475.6
Jan. 6, 2010 (CN) 201010003832.0
Jan. 6, 2010 (CN) 201010003852.8

(51) Int. Cl. B26B 15/00

(52) U.S. Cl. 30/228

(57) ABSTRACT

A shearing tool configured to be detachably connected to a portable oscillatory power tool is disclosed. The power tool includes a head housing and an output shaft with an axis. The output shaft extends outwardly from the head housing and is able to pivot back and forth about the axis. The shearing tool includes a fixed blade mounted relative to the head housing and a movable blade connected to the output shaft. The movable blade can pivot back and forth about the axis relative to the fixed blade. The fixed blade and the movable blade are connected to the portable power tool by a same fastening element. The shearing tool has simple operational steps and simple structure, thus to facilitate assembling.

### FIELD OF THE INVENTION

The present invention relates to a shearing tool, more particularly to a shearing tool configured to be detachably connected to a portable oscillatory power tool is disclosed.

### BACKGROUND OF THE INVENTION

An oscillatory power tool is a portable oscillatory power tool commonly used in this field. The operating principle is that the output shaft pivots back and forth about its own axis. Therefore, when the user installs different working heads at the free end of the output shaft, wherein the commonly applied working heads include straight saw blade, round saw blade, triangular disc sander and spade-shaped scraper, diversified operation functions such as sawing, grinding and scraping can be used to adapt to different working demands.

Shearing is also one of the frequently used operation means. Generally, the shearing operation is achieved by a shearing tool. This shearing tool includes two blades which are pivoted together. The two blades have a knife-edge and the two knife-edges face each other. When the user opens the two blades relative to one another, the opening action of the shearing is done; the closing action of the shearing is done when the user closes the two blades relative to one another. Shearing function can be obtained in such way.

Certainly, another kind of shearing mode commonly used is electric shearing tools with two blades. Generally, one blade is a fixed blade and the other one is a movable blade relative to the fixed blade. The movable blade connects with the transmission shaft and generates reciprocating movement under the action of a motor; while the other blade keeps still. Shearing function of the shearing tool is obtained via the reciprocating movement of the movable blade.

### SUMMARY OF THE INVENTION

It is an object of the present invention to provide a shearing tool. As an integrated attachment adapted for an oscillatory power tool, the shearing tool expands an application scope of the oscillatory power tool. It has a simple configuration and is easy to be assembled.

To solve above problem, the present invention provides a shearing tool detachably connected to an oscillatory power tool, the oscillatory power tool comprising:

a head housing; and

an output shaft extending outwardly from the head housing and having an axis, the output shaft being configured to oscillate about the axis;

the shearing tool comprising:

a fixed blade fixed to the head housing;

a movable blade connected to the output shaft and configured to oscillate about the axis with respect to the fixed blade.

Preferably, the fixed blade and the movable blade are connected to the power tool by a same fastening element.

Preferably, the fastening element comprises a bolt and configured to engage with the output shaft.

Preferably, the shearing tool further comprises a connecting seat connected with the head housing, the connecting seat comprising a base portion and a locating portion extending from the base portion, the locating portion configured to partially cover the head housing.

Preferably, the head housing is configured as an angular shape, and the locating portion comprises a U-shaped section matching with the head housing in a direction perpendicular to the axis of the output shaft and an arced section matching with the head housing in a direction along the axis.

Preferably, the base is configured as a ring.

Preferably, the shearing tool further comprises a connecting seat and a cover fixed to the connecting seat, the movable blade being located between the connecting seat and the cover.

Preferably, the cover is ring shaped and comprises a first recess, a second recess, and a ring recess located at a centre of the cover, the first and second recess being arranged alternately in a circle direction of the cover with a step therebetween.

Preferably, the movable blade comprises a mounting portion having a mounting hole engaging with the output shaft, a head portion having a knife-edge, and a connecting portion interconnecting the mounting portion and the head portion.

Preferably, the mounting portion of the movable blade is configured as a ring shape and is accommodated in the ring recess.

Preferably, the connecting portion is configured as a rectangular shape and has a width less than the first recess, thereby being accommodated in the first recess.

Preferably, the connecting seat comprises a base portion and a locating portion extending from the base portion, the base portion being configured as a ring shape and comprising a bearing retainer located on an interior surface thereof and a bolt receiver located on an exterior surface thereof.

Preferably, the fixed blade comprises a fixed portion having a bolt hole, a head portion having a knife-edge, and a curved portion interconnecting the fixed portion and the head portion, the bolt receiver penetrating the bolt hole for fix the fixed blade to the connecting seat.

Preferably, the fixed portion has a width less than a width of the second recess of the cover, and is accommodated in the second recess.

Preferably, the cover comprises a locating slot, the connecting base comprises a locating post corresponding to the locating slot, the fixed portion of the fixed blade further comprises a locating hole aligned with the locating slot, and the locating post penetrates through the locating hole into the locating slot.

Preferably, the mounting portion of the movable blade contacts the bearing retainer of the connecting base surface-to-surface, and the head portion of the movable blade is disposed between the head portion of the fixed blade and the fixed portion.

Preferably, the shearing tool further comprises a connecting base and a drive element, the connecting base interconnecting the head housing and the fixed blade, the drive element interconnecting the output shaft and the movable blade.

Preferably, the connecting base is ring shaped and comprises a cavity for receiving the drive element, and a bearing is disposed between the connecting base and the drive element so that the drive element is able moving relative to the connecting base.

Preferably, the shearing tool further comprises a block element mounted on the connecting base by a plurality of screw holes formed on the connecting base.

Preferably, the connecting base further comprises a first bulge having a first fixed hole, and the fixed blade is mounted on the first bulge by a bolt.

Preferably, the drive element has two opposite surfaces, one of the two surfaces defining a recessed portion, the other one of the two surfaces defining a plurality of bores between each two of which a locating protrusion is disposed.

Preferably, the movable blade defines a through hole aligned with the bore and a locating hole aligned with the locating protrusion, and the movable blade is mounted on the drive element by a bolt.

Preferably, the fixed blade is approximately trapezoidal shaped and comprises a fixed portion and a knife-edge, the knife-edge being located at a waist side of the fixed blade, the movable blade being configured as an L-shape and comprises two free ends, one of the two free ends defining a mounting portion, the other one of the two free ends being configured as an inverted trapezoidal shape and comprising a knife-edge at a waist side thereof, the two knife-edges overlapping each other.

Preferably, the shearing tool further comprises a bracket, the bracket comprising a contacting portion, an upholding portion perpendicular to the contacting portion, and a projecting portion abutting against the fixed blade.

### BRIEF DESCRIPTION OF THE DRAWINGS

FIG. 1 is a perspective view of the oscillatory power tool fixed the shearing tool in accordance with the first embodiment of the present invention;

FIG. 2 shows a perspective view of a head housing of the power tool according to FIG. 1;

FIG. 3a shows a perspective view of the shearing tool according to FIG. 1 in front view;

FIG. 3b shows a perspective view of the shearing tool according to FIG. 1 in rear view;

FIG. 4 is an exploded view of the shearing tool according to FIG. 1;

FIG. 5a is a front view of the shearing tool and the power tool according to FIG. 1;

FIG. 5b is a cross-section view of the shearing tool and the power tool according to FIG. 1;

FIG. 6a is a schematic view of the shearing tool, in which the movable blade moves left relative to the fixed blade;

FIG. 6b is a schematic view of the shearing tool, in which the movable blade holds still relative to the fixed blade;

FIG. 6c is a schematic view of the shearing tool, in which the movable blade moves right relative to the fixed blade;

FIG. 7 is a perspective view of an oscillatory power tool fixed a shearing tool in accordance with a second embodiment of the present invention;

FIG. 8 is a schematic view of a head housing of the power tool according to FIG. 7;

FIG. 9 is a perspective view of the shearing tool according to FIG. 7;

FIG. 10 is an exploded view of the shearing tool according to FIG. 9;

FIG. 11 is a vertical view of a connecting seat of the shearing tool according to FIG. 9;

FIG. 12 is a schematic view of the connecting seat viewed from an A direction according to FIG. 11;

FIG. 13 is a schematic view of a cover of the shearing tool according to FIG. 9;

FIG. 14 is a vertical view of the cover according to FIG. 13;

FIG. 15 is a front view of the shearing tool and the power tool according to FIG. 9;

FIG. 16 is a cross-section view of the shearing tool and the power tool according to FIG. 9;

FIG. 17 is a schematic view of the shearing tool according to FIG. 9, in which the movable blade moves left relative to the fixed blade;

FIG. 18 is a schematic view of the shearing tool according to FIG. 9, in which the movable blade holds still relative to the fixed blade;

FIG. 19 is a schematic view of the shearing tool according to FIG. 9, in which the movable blade moves right relative to the fixed blade;

FIG. 20 is a cross-section view of the shearing tool along line B-B of FIG. 17.

### DETAILED DESCRIPTION OF PREFERRED EMBODIMENTS

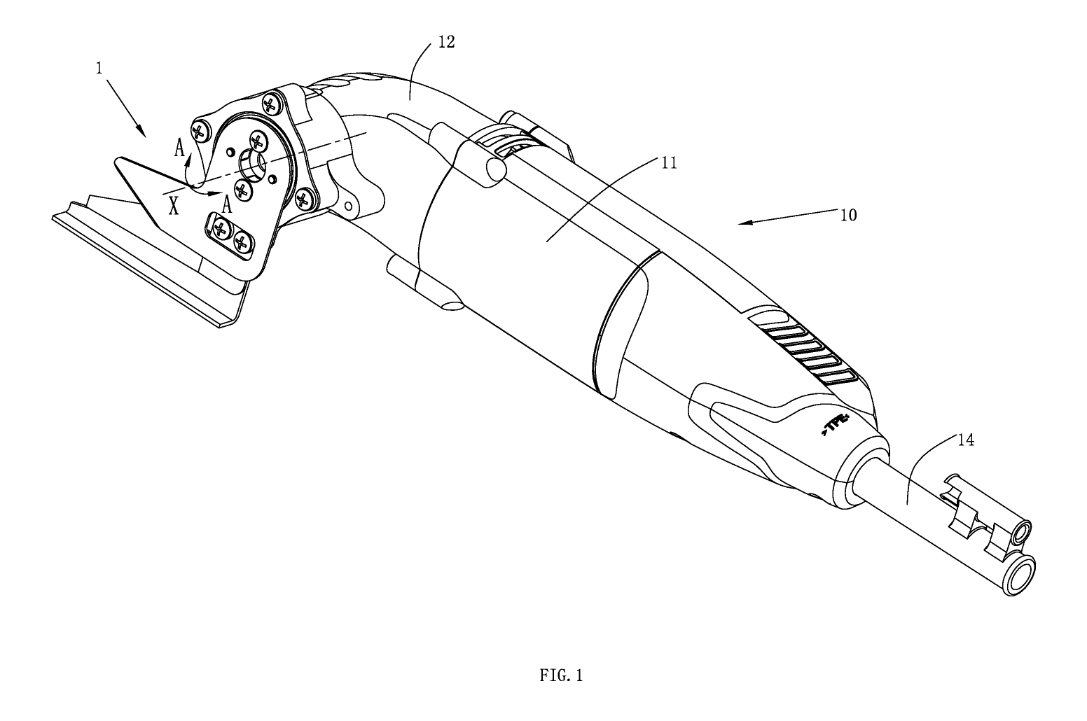

As shown in FIGS. 1 and 2, in the first preferred embodiment of the present invention, a shearing tool 1 adapted for shearing operations which can be applied to the oscillatory power tool is provided. The oscillatory power tool, designated to be Number 10, comprises a cylindrical housing 11 and a head housing 12 connected at the front end of the housing 11, wherein the head housing 12 has a right angle arrangement, an output shaft 13 (as shown in FIG. 2) extends therethrough, the free end of the output shaft 13 is configured as a regular hexagon and has an axis X. A motor for providing driving force and a transmission assembly for transmitting torque are mounted inside the housing 11 of the oscillatory power tool 10. A cable 14 is connected at the tail end of the housing 11 to supply power to the motor. When the motor is enabled and generates driving force, the torque of the driving force is transmitted to the output shaft 13. Under the action of the torque, the output shaft 13 oscillates about the axis with the movement direction as shown in double-headed arrow A-A of FIG. 1.

It shall be noted that, the oscillatory power tool 10 used herein is the commonly used oscillatory power tool in this field. The oscillatory power tool is a power tool making oscillatory movements based on the oscillatory principle. Generally, the motor drives the eccentric wheel connected on the motor shaft to rotate, a fork assembly is linked with the eccentric wheel in the horizontal direction, and the other end of the fork assembly is connected with the output shaft. When the eccentric wheel makes eccentric rotation, the fork assembly is driven to oscillate about the axis of the output shaft. Therefore, when the user configures working heads at the free end of the output shaft, the working head can also generate oscillatory movement.

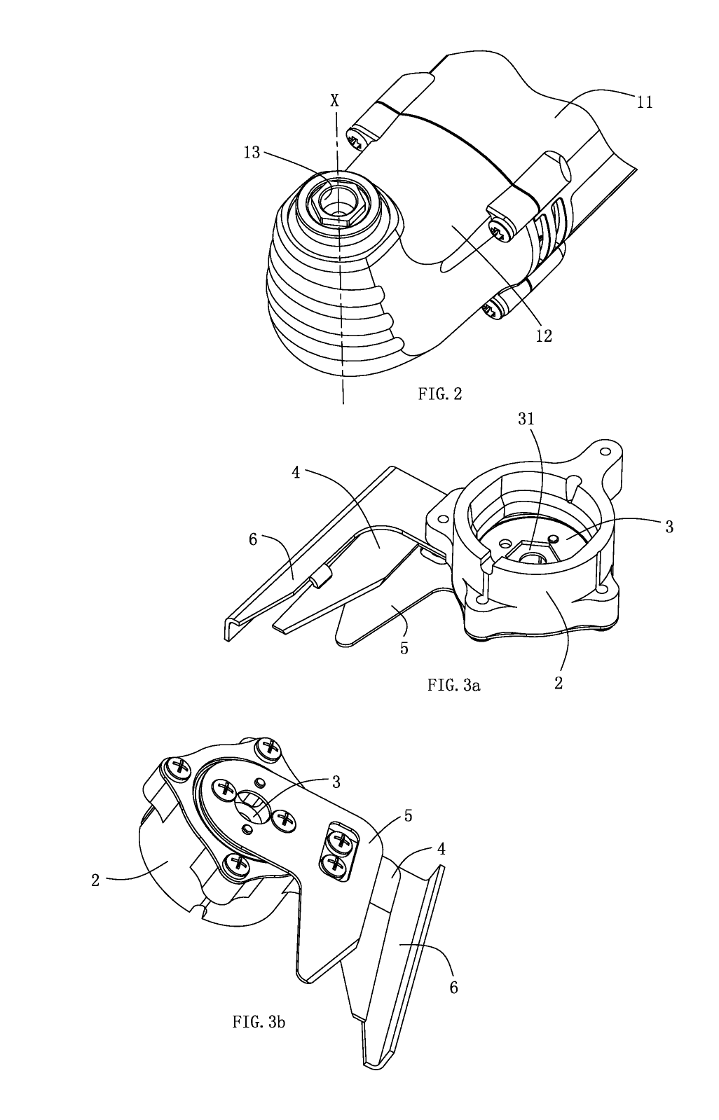

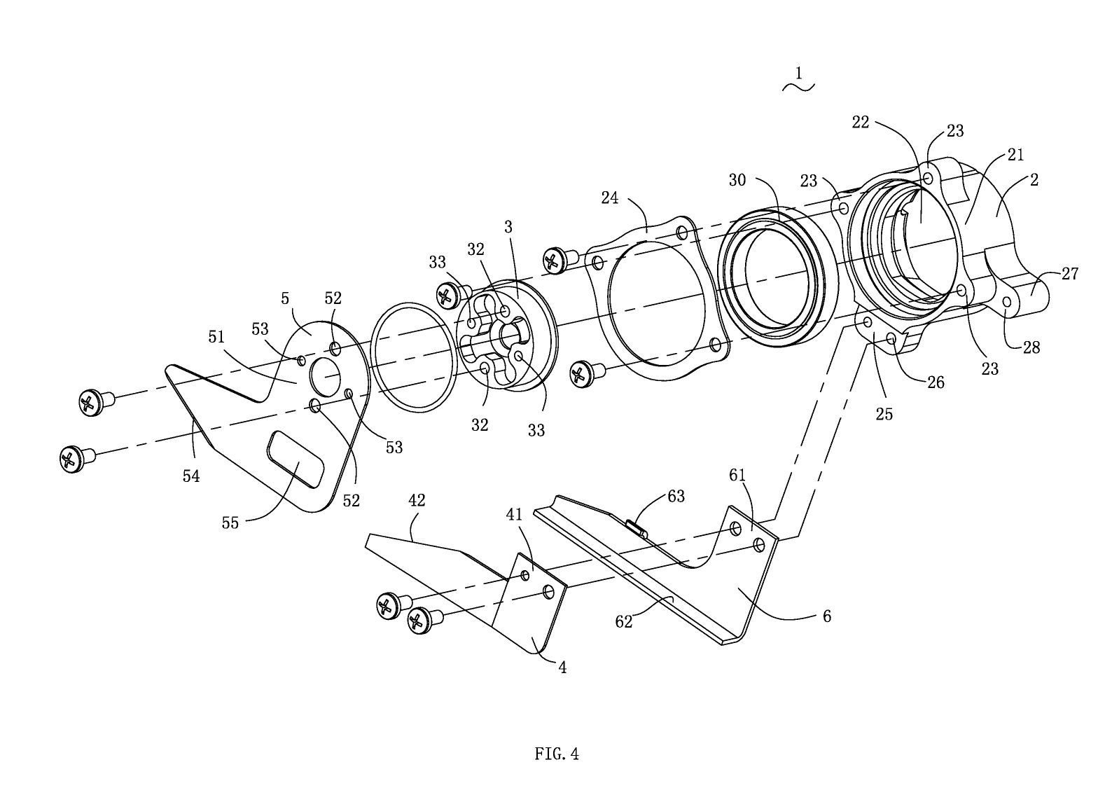

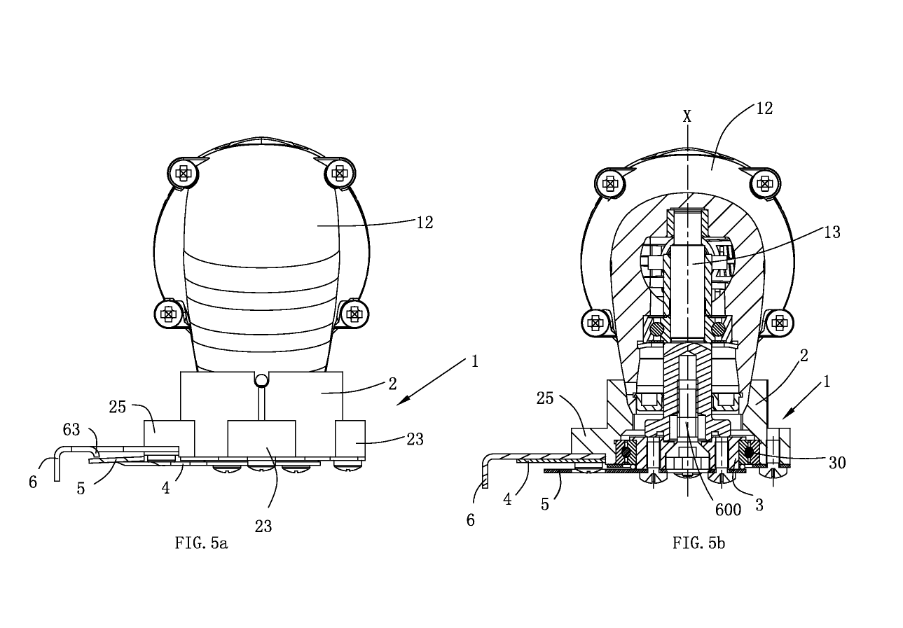

As shown in FIGS. 3 and 4, the shearing tool 1, connected on the head housing 12, is an integrated accessory detachably connected to the head housing 12. It is connected with the output shaft 13 via a fastening element 600 (see FIG. 5b). In the present invention, the fastening element 600 is a bolt fit for the corresponding threaded hole on the output shaft and is capable of being fastened. It is known to the person who skilled in this art, to achieve the same function by fastening means well-known in this field such as a pin or a spring.

The shearing tool 1 comprises a connecting seat 2, a drive element 3 mounted inside the connecting seat 2, a fixed blade 4 connected on the connecting seat 2, a movable blade 5 connected on the connecting seat disk 3 and a bracket 6. The connecting seat 2 is in the shape of approximate cylinder. It includes a circular-ring side wall 21 and a cavity 22 enclosed by the side wall 21. When the connecting seat 2 is connected to the head housing 12 of the oscillatory power tool 10, the tail end of the head housing 12 is accommodated in the cavity 22. Moreover, the output shaft 13 of the oscillatory power tool 10 is also accommodated in the cavity 22. On the exterior of the side wall 21, three screw holes 23 and one first bulge 25 are extended at an interval of 90°. The three screw holes 23 are used to fix with a block element 24 so as to seal and support the drive element 3. A mounting hole 26 is configured on the first bulge 25 to connect the fixed blade 4 and the bracket 6 by a bolt. A second bulge 27 is extended on the exterior of the side wall 21 at an interval of 90° from the first bulge 25. In addition, a second fixed hole 28 is set on the second bulge 27 to fix the connecting seat 2 with the head housing 12 of the oscillatory power tool 10.

It shall be noted that the second fixed hole 28 herein mainly plays a role of installation assistance. Based on the connection between the movable blade and the output shaft, a bolt can be also used for fixed connection to strengthen connection and installation effect. Certainly, the shearing tool can be installed and fixed only by the fastening element 600 without using such second fixed hole 28.

Corresponding to the output shaft 13, the drive element 3 is set inside the connecting seat 2, namely in the cavity 22. And a bearing 30 is mounted between the side wall 21 and the drive element 3. So that the drive element 3 can generate rotation relative to the side wall 21. A recessed portion 31 is mounted on the side of the drive element 3 towards the output shaft 13 (as shown in FIG. 2a). In this embodiment, the recessed portion 31 corresponding to the free end of the output shaft 13 is also in regular hexagon, thus the output shaft 13 can be accurately inserted into the recessed portion 31. Two bores 32 symmetrically relative to the recessed portion 31 are mounted on the other side of the drive element 3, and two locating protrusions 33 are symmetrically relative to the recessed portion 31 are configured between the two bores 32. In the preferred embodiment, two bores 32 and two locating protrusions 33 are set respectively and arranged alternately. Certainly, their quantity is not limited in the present invention.

As further shown in FIG. 4, the fixed blade 4 is mounted on the first bulge 25 on the side wall 21 of the connecting seat 2 by a bolt. The fixed blade 4 is configured as an approximately trapezoidal shape and comprises a fixed portion 41 and a knife-edge 42. The knife-edge 42 is located at a waist side of the trapezoidal structure. The fixed blade 4 is made of flexible material which can be bent to certain shapes. In this way, when the fixed blade and movable blade have abrasion due to long-term operation, a clearance therebetween may arise easily. To prevent this, the fixed blade adopts flexible material and presses the movable blade by relying on other elements so that the fixed blade and the movable blade are always kept in a close contacting state.

The movable blade 5 is configured as an L-shape and comprises two free ends. One of the two free ends defines a fixed portion 51, a through hole 52 being aligned with the bore 32 and a locating hole 53 being aligned with the locating protrusion 33. When the movable blade 5 is fixed onto the drive element 3, localization is realized by inserting the locating protrusion 33 into the locating hole 53. Afterwards, a movable bolt 5 passing through the through hole 52 is used to fix the movable blade to the drive element 3. The other free end of the movable blade 5 is configured as an inverted trapezoidal shape relative to the fixed blade 4. Its knife-edge 54 is also at a waist side thereof, thus the two knife-edges 42, 54 of the fixed blade 4 and the movable blade 5 overlap each other alternately. The drive element 3 connected with the movable blade 5 is rotatable relative to the connecting seat 2, so the movable blade 5 is also rotatable relative to the fixed blade 4 which is connected with the connecting seat 2. Thus the knife-edges 42, 54 are transmitted between an opening state and a closing state, realizing shearing function.

In such a way, the fixed blade 4 and the movable blade 5 are integrated to be one unit. The center of the fixed portion 51 of the movable blade 5 is on the axis X of the output shaft 13. The user can mount the shearing tool (a component of the whole set) to the oscillatory power tool or detach it from the power tool only by means of a fastening element 600.

Moreover, in the middle of the movable blade 5, namely in the middle of the L-shaped structure, a through hole 55 is configured in the first bulge 25 corresponding to the connecting seat 2. When the fixed blade 4 is installed on the first bulge 25, the movement of the movable blade 5 may be held back since the bolt may raise protrusion. Therefore, the through hole 55 is set on the movable blade 5 to accommodate the bolt for fixing the fixed blade 4 in the through hole 55 so as to avoid the influence on the rotation of the movable blade 5.

As further shown in FIG. 5, the bracket 6 is mounted on the first bulge 25 outside the side wall 21 of the connecting seat 2 by a bolt. The bracket 6 is configured as an approximately L shape and comprises a fixed portion 61 connected with the first bulge 25 and an upholding portion 62 perpendicular to the fixed portion 61. A projecting portion 63, extended from the side of the upholding portion 62, is closely contacted with the back of the fixed blade 4. Because the fixed blade 4 is made of flexible material, the fixed blade 4 is always pushed towards the movable blade 5 to keep the fixed blade 4 always contacting with the movable blade 5, thus guaranteeing the shearing effect.

Moreover, the upholding portion 62 can be placed as a bracket on the workbench surface for shearing operation. It is convenient to the user.

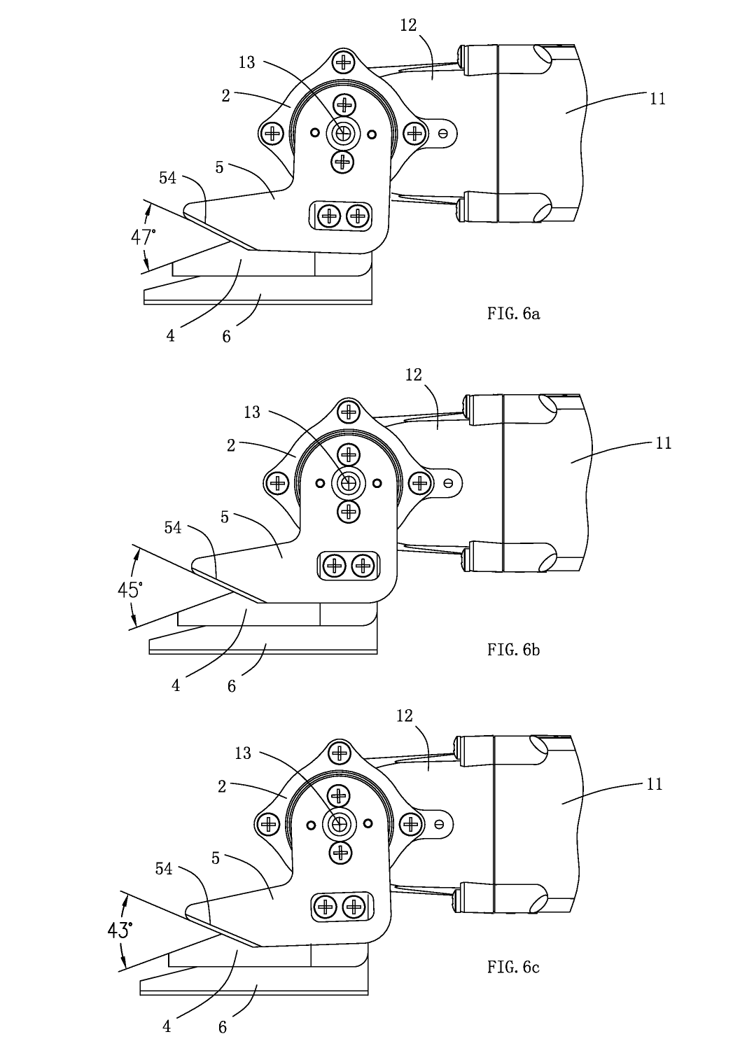

The specific structure features of the shearing tool in the present invention are as described above. FIG. 6 (6a-6c) shows the schematic views of the operating principle of the power tool. As shown in FIG. 6b, when the oscillatory power tool 10 is not started, the output shaft 13 will not oscillate, thus the drive element 3 connecting the output shaft 13 will not oscillate either. The movable blade 5 connected on the drive element 3 is kept in the initial location, namely in the location with the angle formed between the two knife-edges of the movable blade 5 and the fixed blade 4 being 45° as shown in the figure.

As shown in FIG. 6a, when the output shaft 13 drives the drive element 3 to oscillate clockwise, the movable blade 5 will oscillate towards the left side about the axis X, as shown in the figure. The knife-edge 54 moves upwards relative to the fixed blade 4. In this way, the angle formed between the knife-edges is expanded to 47° to constitute an opening operation of the shearing movement.

As further shown in FIG. 6c, when the output shaft 13 generates a reverse oscillation, namely the output shaft 13 drives the drive element 3 to oscillate anticlockwise, the movable blade 5 will oscillate towards the right side about the axis X, as shown in the figure. The knife-edge 54 moves downwards relative to the fixed blade 4. In this way, the angle formed between the knife-edges is diminished to 43° to constitute a closing operation of the shearing movement.

Certainly, the angle herein is indicated for the convenience of explanation only. It can be set to other values for realizing shearing function rather than limited thereby.

The repeated oscillation of the output shaft 13 drives the drive element 3 to keep repeated oscillation either. Therefore, the movable blade 5 connected on the drive element 3 oscillate in the angle range above repeatedly, thus realizing shearing function.

It shall be noted that, the fixed blade 4 of the shearing tool 1 is connected on the connecting seat 2 and the connecting seat 2 is further fixed on the head housing 12 of the oscillatory power tool 10, so the fixed blade 4 keeps still all the time during shearing action, and the movable blade 5 oscillates relative to the fixed blade 4 only.

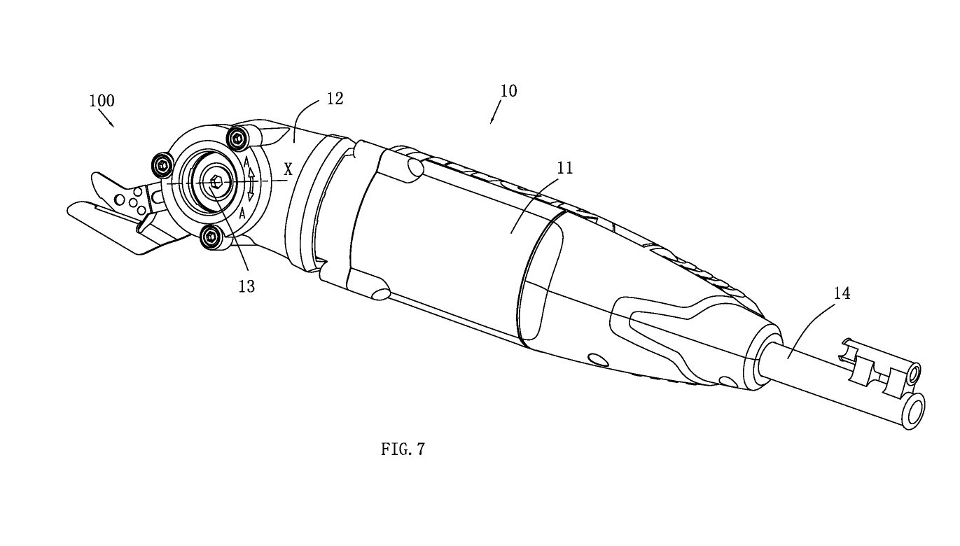

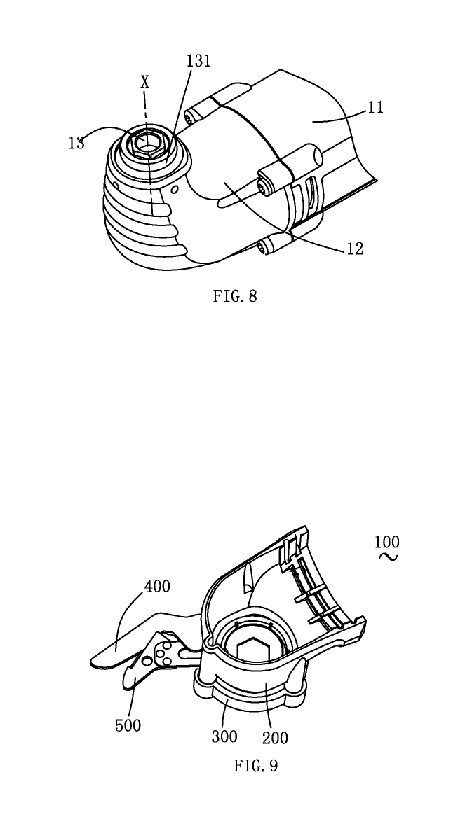

As shown in FIG. 7, in the second embodiment of the present invention, a shearing tool 100 adapted for shearing operation which can be applied to the oscillatory power tool is provided. The oscillatory power tool, designated to be Number 10, comprises a cylindrical housing 11 and a head housing 12 connected at the front end of the housing 11 and is configured as an angular shape (the left side of FIG. 1 is defined as front end), wherein an output shaft 13 extends from the head housing 12. As shown in FIG. 8, the free end of the output shaft 13 is in regular hexagon and has an axis X. The free end of the output shaft 13 further forms a ring-shaped flange 131.

As further shown in FIG. 7, a motor (not shown) for providing driving force and a transmission assembly (not shown) for transmitting torque are mounted inside the housing 11 of the oscillatory power tool 10. A cable 14 is connected at the tail end of the housing 11 to supply power to the motor. When the motor is enabled and generates driving force, the torque of the driving force is transmitted to the output shaft 13. Under the action of the torque, the output shaft 13 oscillates about the axis X with the movement direction as shown in double-headed arrow A-A direction of FIG. 7.

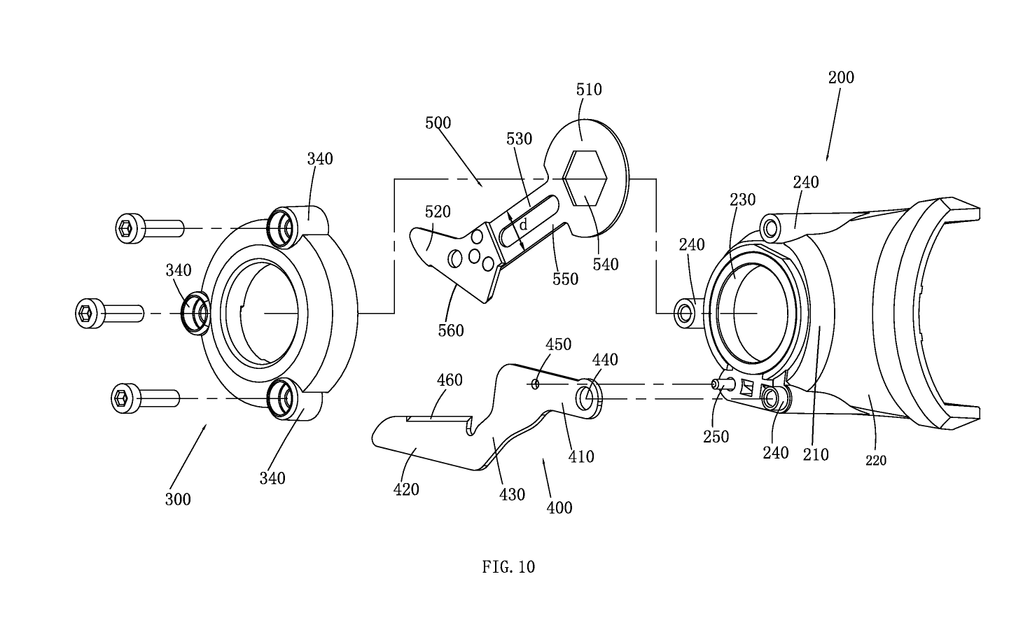

As shown in FIGS. 9 to 11, the shearing tool 100, connected on the head housing 12, is an integrated accessory detachably connected to the head housing 12. It is connected with the output shaft 13 via a fastening element 600 (see FIG. 17).

The shearing tool 100 comprises a connecting seat 200, a cover 300 fixed to the connecting seat 200, a fixed blade 400 connected to the connecting seat 200 and a movable blade 500 which is arranged between the connecting seat 200 and the cover 300 moves relative to the fixed blade 400.

The connecting seat 200 comprises a base portion 210 in approximate circular-ring shape and a locating portion 220 extending from the base portion 210. A bearing retainer 230 is fixed inside the circular-ring base portion 210, wherein the bearing retainer 230 is made of metal material and its diameter is similar to that of the flange 131 of the bearing retainer 230 so that the flange 131 can be fully accommodated in the bearing retainer 230 and the two parts are closely contacted. Several bolt receivers 240 are mounted outside the base portion 210 and in vertical direction along the head housing 12. In this embodiment, there are three such bolt receivers 240 which are uniformly arranged around the base portion 210. In addition, the connecting base 200 comprises a locating post 250 for fixing the cover 300.

As shown in FIGS. 12 and 13, the shape of the locating portion 220 is approximately similar to the lower part of the head housing 12. A U-shaped section 221 is configured along the longitudinal direction of the head housing 12, and similarly, an arced section 222 is mounted along the vertical direction of the head housing 12. In this way, the locating portion 220 can cover the lower part of the head housing 12. Under the joint action of the U-shaped section 221 and the arced section 222, the connecting seat 200 can be rapidly fixed below the head housing 12 and free from aptness to shedding.

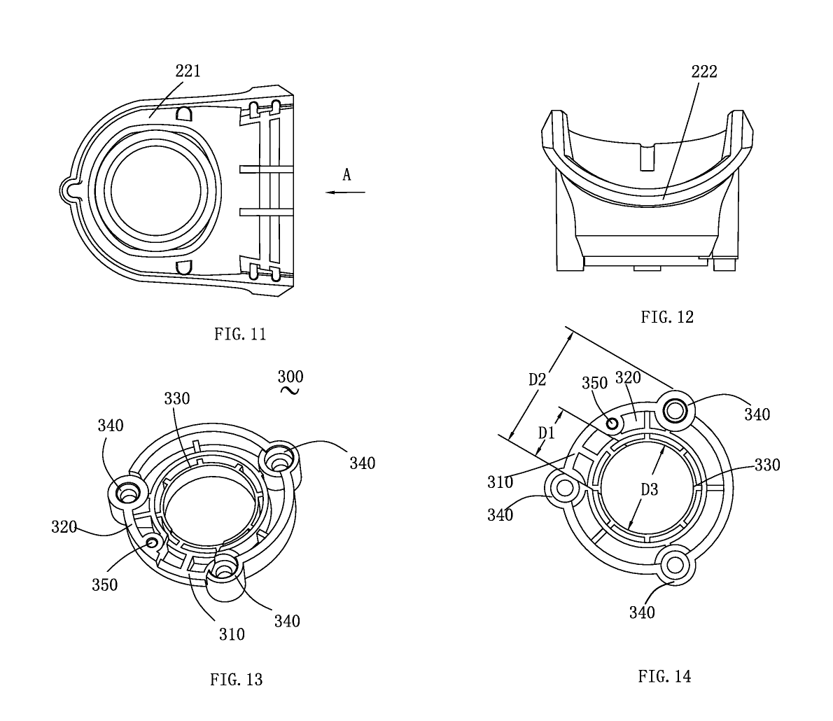

As further shown in FIG. 11, the fixed blade 400 is fixed to the connecting seat 200. It comprises a fixed portion 410 and a head portion 420. They are connected by a curved portion 430 so that the fixed portion 410 and the head portion 420 are located in different planes respectively, thus a location for installing the movable blade 500 is reserved. On the fixed portion 410, a bolt hole 440 and a locating hole 450 are set respectively. Moreover, a bolt receiver 240 passes through the bolt hole 440 to fix the fixed blade 400 to the connecting seat 200. The locating post 250 passes through the locating hole 450 to give assistance to the fixation of the fixed blade 400. On the head portion 420, a knife-edge 460 is formed towards the connecting seat 200.

The movable blade 500 comprises a mounting portion 510, a head portion 520, and a connecting portion 530 interconnecting the mounting portion 510 and the head portion 520. The mounting portion 510 is configured as an approximate ring shape and has a mounting hole 540 in regular hexagon for engaging with the regular hexagon at the free end of the output shaft 13. The connecting portion 530 is configured as a rectangular shape and has a width d. It is provided with a groove 550 for reducing weight. A knife-edge 560 is formed on the head portion 520 towards the head portion 420. The knife-edge 460 of the head portion 420 and the knife-edge 560 of the head portion 520 are relative to each other. When the head portion 520 moves relative to the head portion 420, shearing function is realized.

Also referring to FIG. 14, the cover 300 is configured as a ring. Several screw holes 340 are set corresponding to the bolt receiver 240 on the connecting seat 200. A step is formed on the edge surface. It comprises a first recess 310 for accommodating the movable blade 500, and a second recess 320 for accommodating the fixed blade 400 and a ring recess 330 for accommodating the mounting portion 510 of the movable blade 500. It shall be noted that the width D1 of the first recess 310 is larger than the width d of the movable blade connecting portion 530 of the movable blade 500, so that the oscillation of the movable blade 500 is limited to the width D1. The width D2 of the second recess 320 is lightly larger than that of the fixed portion 410 of the fixed blade 400. The diameter D3 of the ring recess 330 is slightly larger than that of the mounting portion 510 of the movable blade 500. Moreover, the cover 300 comprises a locating slot 350 for inserting and fixing the locating post 250 on the connecting seat 200.

When the shearing tool is in use, the user shall place the movable blade 500 on the connecting seat 200. At this time, the head portion 520 lies between the head portion 420 and the fixed portion 410 of the fixed blade 400, and the mounting portion 510 of the movable blade 500 contacts the end surface of the bearing retainer 230 on the connecting seat 200. Afterwards, the user installs the cover 300 accordingly, namely the locating post 250 is inserted into the locating slot 350 on the cover 300, the connecting portion 530 of the movable blade 500 is accommodated into the first recess 310 of the cover 300, the screw hole 340 is aligned with the bolt receiver 240 on the connecting seat 200 and the cover 300 is fixed onto the connecting seat 200 by means of a bolt. In this way, when the movable blade 500 oscillates relative to the fixed blade 400, the mounting portion 510 of the movable blade 500 and the bearing retainer 230 on the connecting seat 200 generate end surface oscillation. The oscillation amplitude is limited by the width D1 of the first recess 310 on the cover 300.

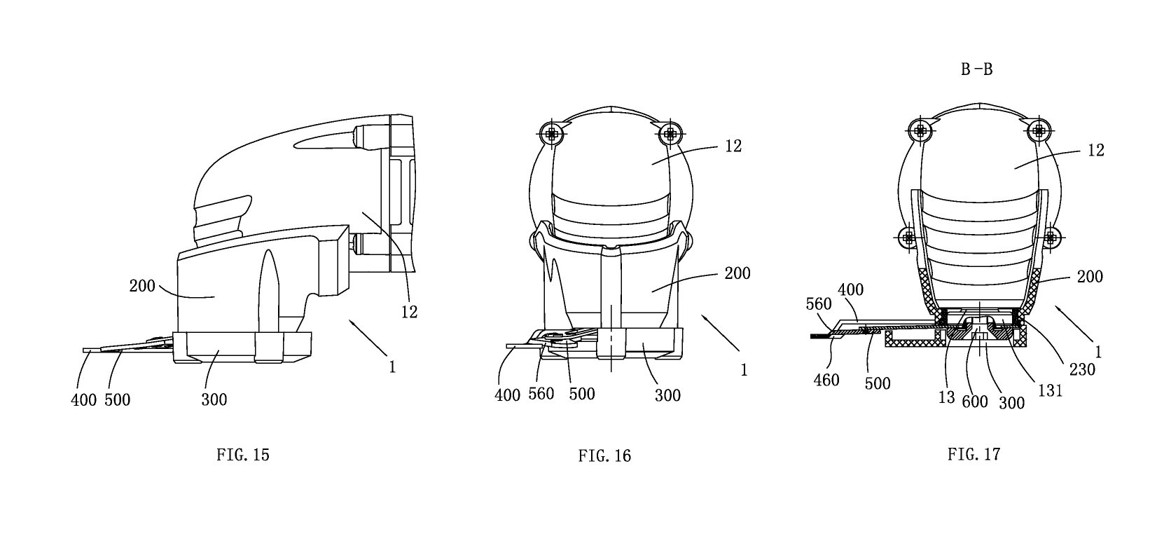

As shown in FIGS. 15, 16 and 20, when the shearing tool 100 is connected to the oscillatory power tool 10, the mounting hole 540 on the movable blade 500 is engaged with the output shaft 13 by a fastening element 600, and the bearing retainer 230 is engaged with the flange 131 on the output shaft 13. When the output shaft 13 oscillates, the movable blade 500 connected on the output shaft 13 is driven to pivot back and forth either, while the fixed blade 400 keeps still. The knife-edges 460, 560 of the head portion 420 and the head portion 520 are contacted alternately, and the head portion 520 oscillates relative to the head portion 420, thus realizing the shearing function.

It shall be specially noted that, the shearing tool in the present invention requires one fastening element only for realizing the attaching and detaching of the integrated accessory since the fixed blade and the movable blade are integrated as a unit, thus avoiding the respective connection with the oscillatory power tool and the output shaft as if they are separate elements, and simplifying the installation of the fittings and improving the user convenience.

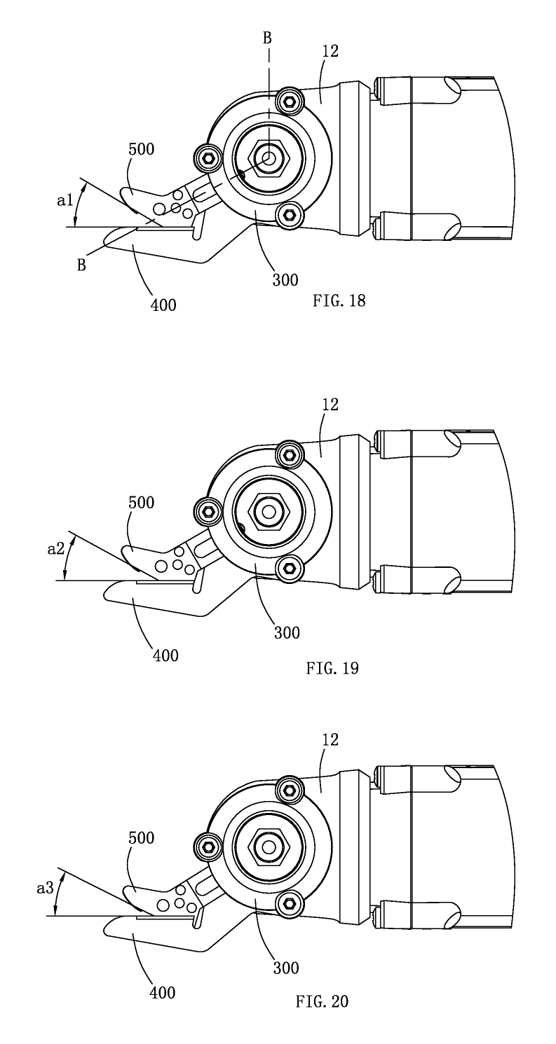

FIGS. 17 to 19 show the schematic view of the operating principle of the shearing tool. As shown in FIG. 18, when the oscillatory power tool 10 is not started, the output shaft 13 will not oscillate, thus the movable blade 500 connected with the output shaft 13 will keep still in initial position rather than oscillate, namely is the position when the angle formed between the knife-edges of the movable blade 500 and the fixed blade 400 is α1, as shown in FIG. 18.

As shown in FIG. 17, when the output shaft 13 oscillates clockwise, the movable blade 500 will oscillate clockwise about the axis X, the knife-edge 560 generates angular displacement relative to the fixed blade 400. In this way, the angle formed between the two knife-edges is expanded to α2 to constitute an opening operation of the shearing movement. As further shown in FIG. 19, when the output shaft 13 generates reverse oscillation, namely when the output shaft 13 oscillates anticlockwise, the movable blade 500 will oscillate about the axis anticlockwise, and the knife-edge 560 generates angular displacement relative to the fixed blade 400. In this way, the angle formed between the two knife-edges is diminished to α3 to constitute a closing operation of the shearing movement. Certainly, the angle herein is indicated for the convenience of explanation only, but not limited to this. It can be set to other values for realizing shearing function rather than limited by this.

The oscillation of the output shaft 13 drives the movable blade 500 keeping oscillation either. The oscillation amplitude is within the angle range above. Repeat the operation in the same way above, shearing function can be obtained.

What we claim:

1. A shearing tool detachably connected to an oscillatory power tool, the oscillatory power tool comprising:
a head housing; and
an output shaft extending outwardly from the head housing and having an axis, the output shaft configured to oscillate about the axis;
the shearing tool comprising:
a fixed blade fixed to the head housing;
a movable blade connected to the output shaft and configured to oscillate about the axis with respect to the fixed blade.

2. The shearing tool of claim 1, wherein the fixed blade and the movable blade are connected to the power tool by a same fastening element.

3. The shearing tool of claim 2, wherein the fastening element comprises a bolt and configured to engage with the output shaft.

4. The shearing tool of claim 1, further comprising a connecting seat connected with the head housing, the connecting seat comprising a base portion and a locating portion extending from the base portion, the locating portion configured to partially cover the head housing.

5. The shearing tool of claim 4, wherein the head housing is an angular shaped, and the locating portion comprises a U-shaped section matching with the head housing in a direction perpendicular to the axis of the output shaft and an arced section matching with the head housing in a direction along the axis.

6. The shearing tool of claim 4, wherein the base is configured as a ring.

7. The shearing tool of claim 1, further comprising a connecting seat and a cover fixed to the connecting seat, the movable blade being located between the connecting seat and the cover.

8. The shearing tool of claim 7, wherein the cover is ring shaped and comprises a first recess, a second recess, and a ring recess located at a centre of the cover, the first and second recess being arranged alternately in a circle direction of the cover with a step therebetween.

9. The shearing tool of claim 8, wherein the movable blade comprises a mounting portion having a mounting hole engaging with the output shaft, a head portion having a knife-edge, and a connecting portion interconnecting the mounting portion and the head portion.

10. The shearing tool of claim 9, wherein the mounting portion of the movable blade is ring shaped and is accommodated in the ring recess.

11. The shearing tool of claim 10, wherein the connecting portion is rectangular shaped and has a width less than the first recess, thereby being accommodated in the first recess.

12. The shearing tool of claim 11, wherein the connecting seat comprises a base portion and a locating portion extending from the base portion, the base portion being ring shaped and comprising a bearing retainer located on an interior surface thereof and a bolt receiver located on an exterior surface thereof

13. The shearing tool of claim 12, wherein the fixed blade comprises a fixed portion having a bolt hole, a head portion having a knife-edge, and a curved portion interconnecting the fixed portion and the head portion, the bolt receiver penetrating the bolt hole for fix the fixed blade to the connecting seat.

14. The shearing tool of claim 13, wherein the fixed portion has a width less than a width of the second recess of the cover, and is accommodated in the second recess.

15. The shearing tool of claim 14, wherein the cover comprises a locating slot, the connecting base comprises a locating post corresponding to the locating slot, the fixed portion of the fixed blade further comprises a locating hole aligned with the locating slot, and the locating post penetrates through the locating hole into the locating slot.

16. The shearing tool of claim 15, wherein the mounting portion of the movable blade contacts the bearing retainer of the connecting base surface-to-surface, and the head portion of the movable blade is disposed between the head portion of the fixed blade and the fixed portion.

17. The shearing tool of claim 1, further comprising a connecting base and a drive element, the connecting base interconnecting the head housing and the fixed blade, the drive element interconnecting the output shaft and the movable blade.

18. The shearing tool of claim 17, wherein the connecting base is ring shaped and comprises a cavity for receiving the drive element, and a bearing is disposed between the connecting base and the drive element so that the drive element is capable of moving relative to the connecting base.

19. The shearing tool of claim 18, further comprising a block element mounted on the connecting base by a plurality of screw holes formed on the connecting base.

20. The shearing tool of claim 19, wherein the connecting base further comprises a first bulge having a first fixed hole, and the fixed blade is mounted on the first bulge by a bolt.

21. The shearing tool of claim 20, wherein the drive element has two opposite surfaces, one of the two surfaces defining a recessed portion, the other surface defining a plurality of bores between every two of which a locating protrusion is disposed.

22. The shearing tool of claim 21, wherein the movable blade defines a through hole aligned with the bore and a locating hole aligned with the locating protrusion, and the movable blade is mounted on the drive element by a bolt.

23. The shearing tool of claim 22, wherein the fixed blade is approximately trapezoidal shaped and comprises a fixed portion and a knife-edge, the knife-edge being located at a waist side of the fixed blade, the movable blade being configured as an L-shape and comprises two free ends, one of the two free ends defining a mounting portion, the other free end being configured as an inverted trapezoidal shape and comprising a knife-edge at a waist side thereof, the two knife-edges overlapping each other.

24. The shearing tool of claim 23, further comprising a bracket, the bracket comprising a contacting portion, an upholding portion perpendicular to the contacting portion, and a projecting portion abutting against the fixed blade.
